(19) United States
(12) Patent Application Publication
(10) Pub. No.: US 2004/0197535 A1
(43) Pub. Date: Oct. 7, 2004

(54) Method and label for authenticating goods

(76) Inventor: Frederick Bleckmann, Barrington, NH (US)

Correspondence Address: NIXON PEABODY, LLP, 401 9TH STREET, NW, SUITE 900, WASHINGTON, DC, 20004-2128, US

(21) Appl. No.: 10/752,225

(22) Filed: Jan. 7, 2004

Related U.S. Application Data
(60) Provisional application No. 60/438,317, filed on Jan. 7, 2003.

(51) Int. Cl. B32B 1/00

(52) U.S. Cl. 428/195.1

(57) ABSTRACT

A method of authenticating and or identifying goods comprises the steps of providing a master repeat of a recognizable design and providing a length of a ribbon of material having the recognizable design repeated along the length thereof. The ribbon of material is subdivided into a plurality of individual labels, each of the plurality of labels having at least a portion of the recognizable design. The labels having at least a portion of the recognizable design are then compared with the master repeat to determine the authenticity of the labels.

### RELATED APPLICATIONS

This application claims priority of U.S. Provisional Application Serial No. 60/438,317 filed Jan. 7, 2003.

This application is related to co-pending U.S. patent application Ser. No. 10/143,842 filed May 14, 2002 entitled “Method and Apparatus for Production of RF Labels” and co-pending U.S. patent application Ser. No. 09/603,234 entitled “Method and Apparatus for Production of Labels” filed on May 14, 2002.

### BACKGROUND OF THE INVENTION

1. Field of the Invention

The present invention relates to a method and label for authenticating and identifying goods, and more particularly to a label made according to the method of the invention having a design which can be matched to the master ribbon of label design to authenticate the label and hence the goods that it is attached thereto

2. Description of the Related Art

The attachment of labels to cloth goods such as clothing, linens and towels is a common practice used to set forth information such as trademarks and trade names, material identification and characteristics, sizes, care instructions, and so forth. In addition, legal requirements necessitate the use of labels in clothing or on linens. A method and apparatus for producing individual folded labels from a ribbon of labels is presented in published PCT application WO 00/50239 and is incorporated in its entirety herein.

Folded labels are commonly used in the industry and come in a number of different forms including endfolds, centerfolds, J folds, Booklet fold, Manhattan-folds, and mitrefold labels. While each of these different forms has a particular use, the centerfold and endfold labels are the most popular.

As fully disclosed in U.S. patent application Ser. No. 10/143,842, commonly owned by the assignee of the present invention, a ribbon of labels with RF devices encapsulated therein can be subdivided into individual RF labels capable of storing and transmitting identifying information that are more comfortable to the apparel customer than current labels. These RF labels provide a first level of authentication and anti-counterfeit protection.

It would be desirable to be able to produce folded labels which provide an additional level of protection to authenticate the goods attached thereto. In addition, it is desirable to produce such labels at a higher speed and at a greater efficiency of production for both label and end product manufacturers, and with fewer defects than current methods.

### SUMMARY OF THE INVENTION

An object of the present invention is to provide steps for producing a ribbon of labels having an overlying repeat or master repeat which extends over a large number of the labels, for example ten labels.

Another object of the present invention is to provide a method of authenticating goods by comparing a finished label to the recognizable design of the random master repeat.

Still another object of the present invention is to provide a method of producing a ribbon of labels which incorporate an overlying repeat of the standard logo repeat length to provide an additional level of verification to authenticate goods.

Yet another object of the present invention is to produce a finished label having a detectable design which is difficult to repeat without reference to the design of the master repeat design.

An additional object of the present invention is to provide a label made according to the method of the present invention which also includes encapsulated within the folded label an embedded device, such as an antenna, a machine readable code, computer chip, radio frequency (RF) inventory/antitheft control devices, acoustical, magnetic or other security or inventory control devices.

In accomplishing these and other objectives there is provided a method of authenticating and or identifying goods comprising the steps of providing a master repeat of a recognizable design and providing a length of a ribbon of material having the recognizable design repeated along the length thereof. The ribbon of material is subdivided into a plurality of individual labels, each of the plurality of labels having at least a portion of the recognizable design. The labels having at least a portion of the recognizable design are then compared with the master repeat to determine the authenticity of the labels.

In accomplishing these and other objectives there is also provided a label formed from a ribbon of woven, thermoplastic material comprising a partial segment of a recognizable design, wherein the segment of recognizable design compares to a larger segment of a master design.

These and other objects, features, aspects, and advantages of the present invention will become more apparent from the following detailed description of the preferred embodiment relative to the accompanied drawings, in which:

### BRIEF DESCRIPTION OF THE DRAWINGS

FIG. 1 is a perspective view of an apparatus for producing a centerfold label.

FIG. 2 is a perspective view of an apparatus for producing an endfold label.

FIG. 3 is a perspective view of an apparatus for producing a folded label having an embedded device incorporated therein.

FIG. 4 is a perspective view of another apparatus for producing a folded label incorporating an embedded device.

FIG. 5 is a perspective view of a third apparatus for producing a folded label incorporating an embedded device.

FIG. 6 is a perspective view of a fourth apparatus for producing a folded label incorporating an embedded device.

FIG. 7A illustrates a ribbon of labels having an overlying master repeat design according to the present invention. FIG. 7B is an individual label cut from the master repeat of FIG. 7A.

FIGS. 8A and 8B illustrate the front and back of a finished label processed from the ribbon of labels of FIG. 7.

FIGS. 9A and 98B illustrate the front and back of another finished label processed from the ribbon of labels of FIG. 7.

### DETAILED DESCRIPTION OF PREFERRED EMBODIMENTS

For a general understanding of the features of the present invention, reference is made to the drawings, wherein like reference numerals have been used throughout to identify identical or similar elements.

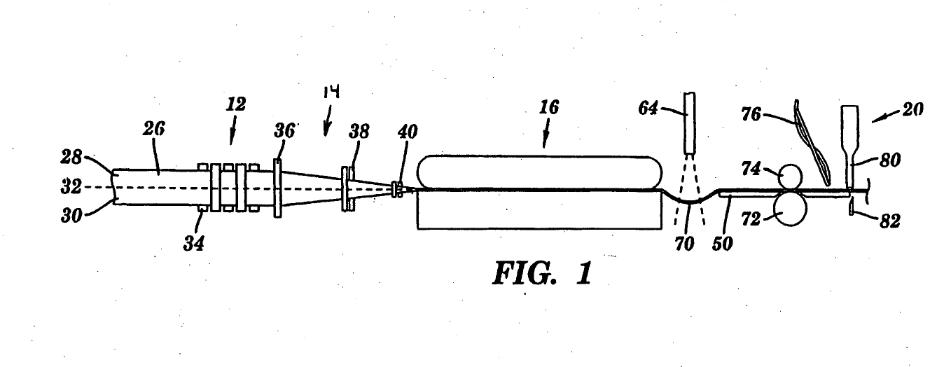

FIG. 1 is a perspective view of a label producing apparatus in a centerfold configuration. The apparatus of FIG. 1 includes a tension equalizer assembly 12, a folding station 14, a pressing station 16, and a cutting station 20.

Ribbon of labels may be formed by weaving a blanket of fabric with warp and weft yarn, and slitting the fabric into ribbons of fabric, such a ribbon made up of labels. The warp yarn running parallel to the slit edges of the ribbon, also defined as the top and bottom edges of the ribbon. The weft yarn running perpendicular to the loom cut edges or ribbon edges. A roll of a ribbon of material containing labels 26 is placed on a tension let-off device (not shown). Regulating tension from the let-off device to press station 16 is important for controlling the ribbon of material 26 during the folding process. As shown in FIG. 1, the upper edge 28 and lower edge 30 of the material 26 must be maintained at essentially equal tensions. The centerline 32 of material 26 is the main control for this adjustment. Centerline 32 is preferably setup equal to the centerline of the press unit 16 and the folding station 14. Raising or lowering the roll from this point can be done to equalize the tensions in the upper and lower edge of the material.

The ribbon of material 26 can be composed of virtually any material that can be cut and pressed including a thermoplastic material (e.g., polyester), acetate, cotton, nylon, linen, paper, rayon and combinations thereof, in woven and non-woven form. Polyester is preferred. The labels can be printed or woven. Woven is preferred.

It is preferred that the logo of the label is made such that it is 90 degrees from the typical orientation used in broadloom, needleloom or shuttleboom weaving of woven labels. Such a typical orientation can be defined by the orientation of the logo to the warp and weft yarn, such as a word in the typical orientation will run its length in the direction or the warp, or parallel to the warp. For woven labels this can be readily done on existing harness repeats. The change of orientation greatly reduces “window shading” (i.e., curling after laundering) and decreases shrinkage when the product is exposed to heat at temperatures above 275° F.

As shown in FIG. 1, the ribbon of material 26 is then guided through a series of adjustable equalizing rollers 14 that make up the tension equalizer assembly 12, to provide an even distribution of tension. After emerging from the equalizing rollers, the ribbon is guided over a folding rod 36. It is preferable that the location of folding rod 36 be kept in center with folding lenses 38 and 40 along centerline 32. Material angle is kept from 5°-170°, more preferably 30°-90°. The distance from folding rod 36 to press unit 16 is dictated by the loom cut width of the material being folded. The wider the tape/ribbon cut, the further folding rod 36 is located from press unit 16.

After passing over the folding rod 36, the ribbon of material 26 enters folding station 14. For producing a centerfold label folding station 14 comprises two folding lenses 38 and 40. Folding lenses 38 and 40 are pivotally mounted on supports and can be adjusted vertically. The lenses are a caliper-like device comprising two adjustable jaws. The lenses restrain and guide the material into an even consistent fold. Lens 38 is a guiding lens used for making for slight adjustments before the material enters lens 40, the working lens that brings the ribbon to a fold. In certain situations a proper fold can be obtained using more or less than two lenses.

The folded material exits the folding station 14 and enters press station 16. The press station 16 subjects the folded material to both heat (100°-400° F.) and pressure. The press station 16 can have multiple heat zones that can be controlled separately. The first heat zone can be designed to carry most of the heat and the heat zones can be designed as a cool down area. The settings of the press station 16 are dictated by the type of material being processed. Thicker materials require a higher press setting and more heat, while thinner materials require less.

The folded pressed ribbon exits the press station and is led to the cutting station 20. A range sensor 64 is used to monitor the slack 70 of the material 26 between press 16 and the plate support and through a control unit. The speed of press 16 is trimmed to stay consistent with the advancing material and the delays set for cut time and acceleration and deceleration of the servo motor (not shown).

Upon advance of the material, downward pressure from roll 74 is dependent on material thickness, and structure. Thinner, looser structure materials require low pressure. Thicker and more stable structures of material require a higher downward pressure.

To maintain the proper alignment for materials with logos and written instructions, such as woven or printed labels, an observation system such as a fiber optic eye 76 is used, which reads color contrast as material advances past its read point. The material advances accelerating from a full stop. When a registration point passes under eye 76 or when eye 76 sees a color change an immediate interrupt signal is sent to the controller, at this point the servo motor, via roller 72, advances the material the distance set in the operator interface. The deceleration is calculated so that the material advance will be accurate to +/−0.05 mm. At this point the material remains stopped for the cutting, e.g., knife delay time set on the operator interface. The material then advances and follows the same sequence above.

A typical setting for the advance is the width of the label (length along loom cut edge) minus 5 mm. This number may be adjusted to influence centering of the logo. Additional adjustment can be made if necessary.

The material is cut at the cutting station 20 to form folded labels using an ultrasonic system comprising a horn 80 and anvil 82. For example, ultrasonic horn 80 has sound waves moving through it at a frequency of 20 KHz. The residence of these waves can be magnified through proper booster and horn combination.

The anvil 82 is actuated at an adjustable pressure to collide with horn 80. The material 26 passes between horn 80 and anvil 82 and is exposed to very high-localized heat, cutting and sealing the material. The larger the radius on anvil 82 the larger the seal area and the more pressure required for a cut. The default delay time for the knife up is calculated and taken into account. For example, a typical delay is 70 ms, which may be adjusted if necessary to accomplish the desired results. Ultrasonic rotary dies can also be used.

The cutting station can utilize other known cutting techniques to subdivide the ribbon into individual labels. Such techniques include, for example, cold or hot shearing knives, hot fuse knives that squeeze off the product during cutting, extreme high mechanical pressure, high-pressure air, high-pressure water, laser cutting, rotary die cutters, and others.

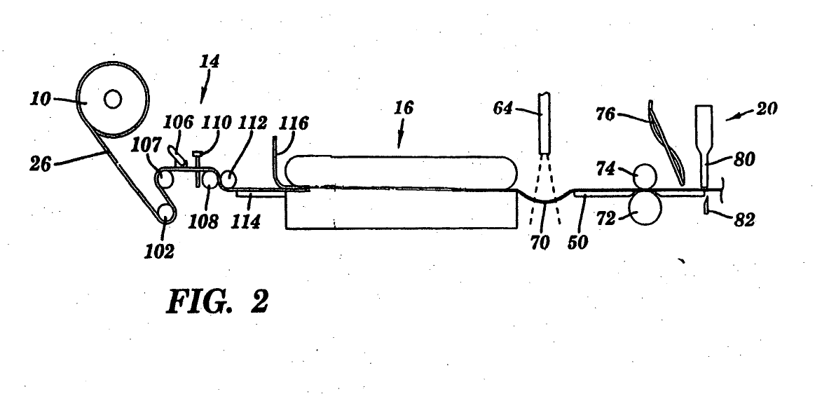

FIG. 2 illustrates an apparatus for forming an “end-fold” label. The material 26 is distributed from tension roll 10 and passed through folding station 14. In this embodiment, the folding station 14 is comprised of services of guide rollers 102-108 and fold pins 110. Guide rollers 102 position the ribbon of material 26. Adjustable guides on rollers 102 are moved into the material edge. Guide roller 106 exerts pressure on the center of the material to prevent the ribbon from puckering in the center. Folding pins 110 fold the edges of the fabric and roller 108 holds the fold. Heat roller 112 presets the fold (100° C.-145° C.). Guide 114 holds the fold in place before the folded ribbon enters the press station 16. The press station 16 can be equipped with a hold-down spring 116 to maintain the fold in place when the press is lifted. The apparatus further includes a cutting station as depicted in FIG. 1.

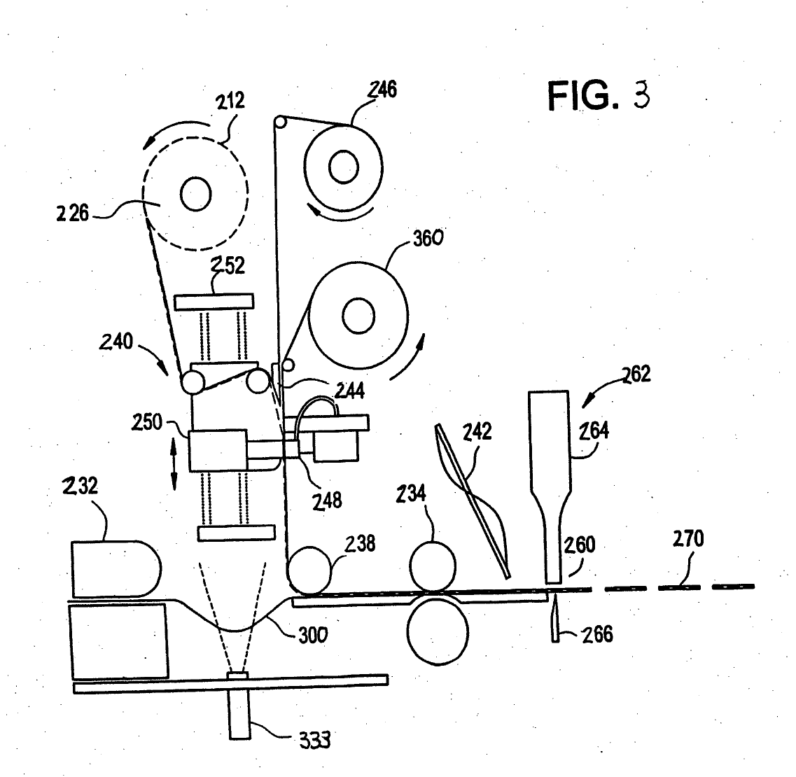

FIG. 3 is a perspective view of an apparatus for attaching a device, for example a RF device, to a woven label. A carrier strip 212 having the devices adhered thereto is mounted on a roller 226. A folded ribbon 300 of material containing labels is advanced from a press station 232 via a drive roller 234. As will be described herein, the ribbon of labels 300 incorporates a design forming a master ribbon repeat.

Like in the above apparatuses, the folded ribbon of labels 300 can be composed of virtually any material that can be cut and pressed including a thermoplastic material (e.g., polyester), acetate, cotton, nylon, linen, paper, rayon and combinations thereof, in woven and non-woven form. Polyester is preferred. The labels can be printed or woven, however, woven is preferred.

In the folding station (not shown) folded label ribbon 300 can be guided through a series of adjustable equalizing rollers (not shown) that make up the tension equalizer assembly to provide an even distribution of tension. After emerging from the equalizing rollers, the ribbon is guided over a folding rod (not shown).

The folded material exits the folding station and enters the press station 232. The press station subjects the folded material to both heat (100°-400° F.) and pressure. A range of pressure between 5-80 pounds of force is preferred. In one embodiment, the press unit includes a support frame upon which are movably affixed belt rolls about which is positioned a high temperature resistant endless conveyor belt. The belt may be driven at selected, controlled, constant speeds by known means such as an AC or DC electric drive motor and speed regulator or controller. Between the affixed belt rolls are a series of rollers, spring mounted to the support frame, upon which the top of the conveyor rides.

The speed of the press station motor can be trimmed with an ultrasonic range-finder that is wired into the motor controller inside the unit. A speed signal is sent to the servo-motor. From this signal a calculation is made and held in memory. The ultra sonic range finder makes a reading of the slack of material as it travels between press station and cutting station. This is added to the number held in memory and this sum is sent to the belt drive motor to control belt speed.

The press station can have multiple heat zones that can be controlled separately. The first heat zone can be designed to carry most of the heat and the heat zones can be designed as a cool down area. The settings of the press station are dictated by the type of material being processed. Thicker materials require a higher press setting and more heat, while thinner materials require less.

The folded material travels though the press unit via a conveyer mechanism. It is this conveyor mechanism that provides a linear advance pulling the ribbon from the tension let off device through the folding station. Other mechanisms for linear advance can be used.

The folded pressed ribbon exits the press station and is led to the cutting station on a support plate. Upon advance of the material, downward pressure from the roll is dependent on material thickness, and structure. Thinner, looser structure materials require low pressure. Thicker and more stable structures of material require a higher downward pressure.

Referring once again to FIG. 3, a sensor 333 is used to monitor and control the slack of the folded ribbon of labels 300 between an applicator unit 240, which will be described further herein, and drive roller 234 through a control unit (not shown). The speed of the applicator 240 is controlled to stay consistent with the advancing material and the delays set for cut time and acceleration and deceleration of the servo motor that turns drive roller 234.

A roll of ribbon of material 360 is also advanced via drive roller 234. Drive roller 234 pulls folded ribbon of labels 300 and fabric ribbon of material 360 forward and under a fiber optic eye 242. To maintain the proper alignment for materials with logos and written instructions such as woven or printed labels, the fiber optic eye is used, which reads color contrast as material advances past its read point. When a registration point passes under the eye or when the eye sees a color change an immediate interrupt signal is sent to the controller, at this point the servo motor, via roller 234, advances the material the distance set in the operator interface. The deceleration is calculated so that the material advance will be accurate to +−0.05 mm. At this point the material remains stopped for the cutting, e.g., knife delay time set on the operator interface. The material then advances and follows the same sequence above.

At the stop, carrier strip 212 is advanced over a peeler 244 and devices 200 are presented to ribbon of material 360. Device 200 can be an embedded device, such as an antenna, a machine readable code, computer chip, radio frequency (RF) inventory/antitheft control devices, acoustical, magnetic or other security or inventory control devices. The carrier strip minus devices 200 is rewound unto roller 246. Applicator 240 includes an anvil and attached piston 248. Anvil 248 includes a vacuum device which attracts ribbon of material 360. The piston activates an ultrasonic horn 250 which welds the RF device to ribbon of material 360. The applicator unit is adjustable via a frame 252 to align with the logo on folded ribbon of labels 300.

The ribbon of material 360 with the RF devices 200 mounted thereon is guided by roller 238 and drive roller 234 to cutting station 260. The RF device is registered with the logo on the label ribbon by advance of both ribbons 300, 360 through drive roller 234 and optic eye 242.

The material is cut at cutting station 260 to form folded labels 270 using an ultrasonic system 262 comprising a horn 264 and an anvil 266. For example, the ultrasonic horn 264 has sound waves moving through it at a frequency of 20-40 KHz. The residence of these waves can be magnified through proper booster and horn combination.

Unlike centerfold labels produced using traditional techniques, the centerfold label of the present invention has the front and back folds sealed together along an edge with the RF device therein. By using alternative folding stations, the apparatus of the present invention can be used to form other varieties of folded labels. For example, to form “end-fold” labels.

FIG. 4 illustrates another embodiment of the present invention wherein the RF device is adhered to the ribbon of labels prior to the folding step. In this embodiment, the roll of ribbon of labels 300 is advanced by two linear drive mechanisms. The first linear advance mechanism 272 is part of the press station and is an uninterrupted linear advance which maintains tension during folding. The second is an indexing mechanism. As in the previous embodiment, mechanism 272 can be a pair of drive rollers or other mechanically equivalent advance. Ribbon of labels 300 is advanced along guide rollers 238 pass optical eye 242 and an application unit 280. Optical eye 242 provides the signal for the placement of the RF device as the ribbon of labels is in motion.

Application unit 280 includes a blower which blows the RF device 200 onto ribbon of labels 300. Blower 280 is commercially available through Label-Aire, Inc., Custom Label-Aire Model 2111M combination air blow left hand labeled. The devices 200 are supported on a roll of carrier strip 212, as previously discussed herein. As in the embodiment of FIG. 3, after RF device 200 is applied to ribbon of labels 300, the carrier strip 212 is separated therefrom by peeler 244 and rewound on roll 246.

The ribbon of labels 300 with RF devices 200 thereon passes through press unit 232′ which adheres the RF devices to ribbon of labels 300. The ribbon of labels 300 then passes into the folding station 274 where the ribbon is folded, as previously set forth herein. After folding, the ribbon can pass to either a cutting device or rolled into a roll for further processing remote from the apparatus.

The apparatus of the invention is particularly suited for insertion of devices such as security and inventory control devices, e.g., radio frequency inventory devices (RFID) tags, devices for authenticity, into labels. RFIDs are known in the art and include that disclosed in U.S. Pat. Nos. 5,874,902; 5,874,896; 5,785,181; and 5,745,036. Such devices can be inserted at a number of locations. By using an ultrasonic cutting system, these devices can be sealed into the bonded top and bottom edges of the material. This will cause the label to be destroyed if the device is removed; thus guaranteeing the tag and label stay as one during processing. At one location, the folded material is opened and the device is inserted at desired positions. At another location, adhesive backed devices are placed on the material before folding. Edge sealing can be achieved with these methods as well.

The RFID tag can include a scannable circuit board chip. The RFID technology will allow a RF label to be read or written to. The ability to write to the RF labels enables users to keep and update a database without the end user being able to alter the information on the embedded circuit board. In addition, the identification information may be reused and written over.

Look-up databases can be readily available to facilitate quick access to the information embedded on the RF labels. Moreover, lost or stolen items having the RF labels can be reunited with its owner or place of origin.

The scannable RF labels enable tracking of inventory, pricing and place of origin, without necessitating human intervention to research such information. The programmable and read-only scannable circuit boards cannot be altered or read without a programmer or reader. The RFID system typically consists of one or more transceivers (exciters) and one or more tags. An RFID tag is an electronic device that generally incorporates a specific and unique identification number, where the number may be read by a RF transceiver (transmitter/receiver) system. The RFID tags may acquire energy from the incident radio frequency field or powered by a battery.

RFID tags typically consist of an antenna or a coil, to collect RF energy, and an integrated circuit (IC) which contains identification code or other information in its on-chip memory. Attaching a RFID tag to a label enables the item to be located and identified with the aid of an RF interrogation system. RFID devices may also take the form of circuits without a chip or memory portion. These circuits are manufactured to react, reflect or absorb a particular frequency. This particular frequency is read and referenced to a data list or predetermined factor. As such, an interrogation system is able to identify information associated with the RFID labels as set forth in the present invention.

Commercially available RFID tags generally operate at low frequencies, typically below 1 Mhz. Although lower frequency devices are more common, a wide range of high frequencies are available, for example, 13.56 Mhz, 915 Mhz, 2.45 Ghz and 5.6 Ghz. Low frequency tags usually employ a multi-turn coil resulting in a tag having a thickness much greater than a standard sheet of paper. 2.45 Ghz and 5.6 Ghz can be done in a single turn or as a die pole antenna. High frequency passive RFID tags, which operate at around 2.54 Ghz, typically consist of a single turn, flat antenna, printed onto a flat single layer sheet of plastic or paper.

The combination of the folded labels with a RF device in the present invention allows for locating and tracking of items, detecting items and reporting of pricing, for example. This ability to read RF labels from codes may be utilized, for example, as the items having the RF labels leave predetermined areas and pass through an exit.

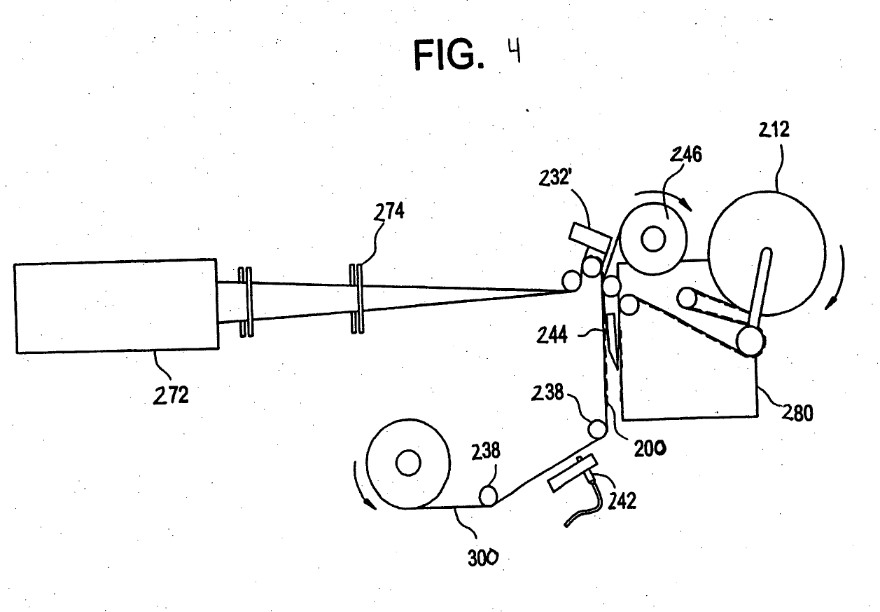

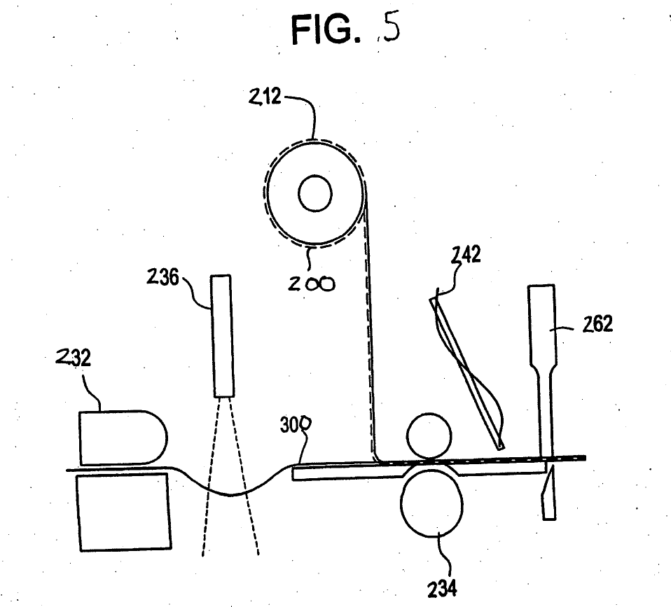

Referring to the apparatus of FIG. 5, the RF devices 200 are not separated from carrier strip 212 but inserted into a label while on strip 212. Carrier strip 212 together with ribbon material 300 are advanced by drive roller 234 past optic eye 242 to ultrasonic cutting station 262 where the labels can be cut.

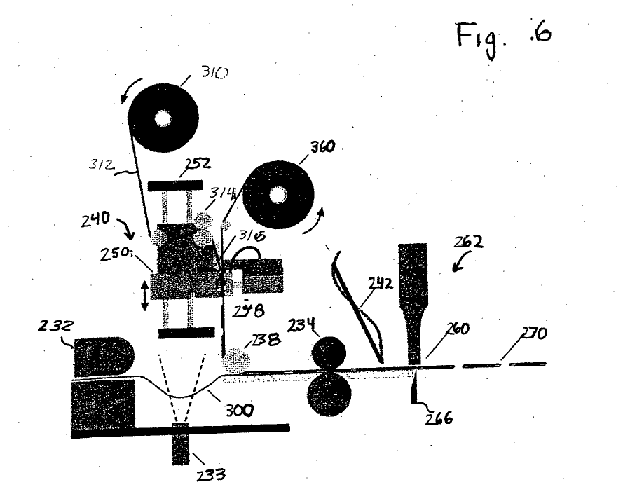

FIG. 6 illustrates another embodiment of an apparatus for attaching RF devices to a woven label. As in the embodiment of FIG. 3, the folded ribbon 300 of material containing labels is advanced from press station 232 via drive roller 234. The roll of ribbon of material 360 is advanced via drive roller 234 which pulls folded ribbon of labels 300 and fabric ribbon of material 360 forward and under fiber optic eye 242. As previously described herein, optic eye 242 reads a color contrast mark on ribbon of labels 300 to a registered location.

The carrier and devices 312 are guided by rollers 314 to a cutting device 316. At cutter 316 an individual device is separated from the length and presented to ribbon of material 360. As in the previous embodiment, anvil 48 includes a vacuum device which attracts ribbon of material 360 and the piston activates ultrasonic horn 250 to weld the device to ribbon of material 360. The ribbon of material 360 with the devices mounted thereon is guided to cutting station 260.

Referring to FIG. 7A, the method of the present invention will be described. A master ribbon of material 360′ includes an over-lying repeat of a design. The design can repeat over a length of labels, for example 10 labels. However, it should be appreciated that the present invention contemplates a wide range of design repeat lengths. For example 2-50 or more.

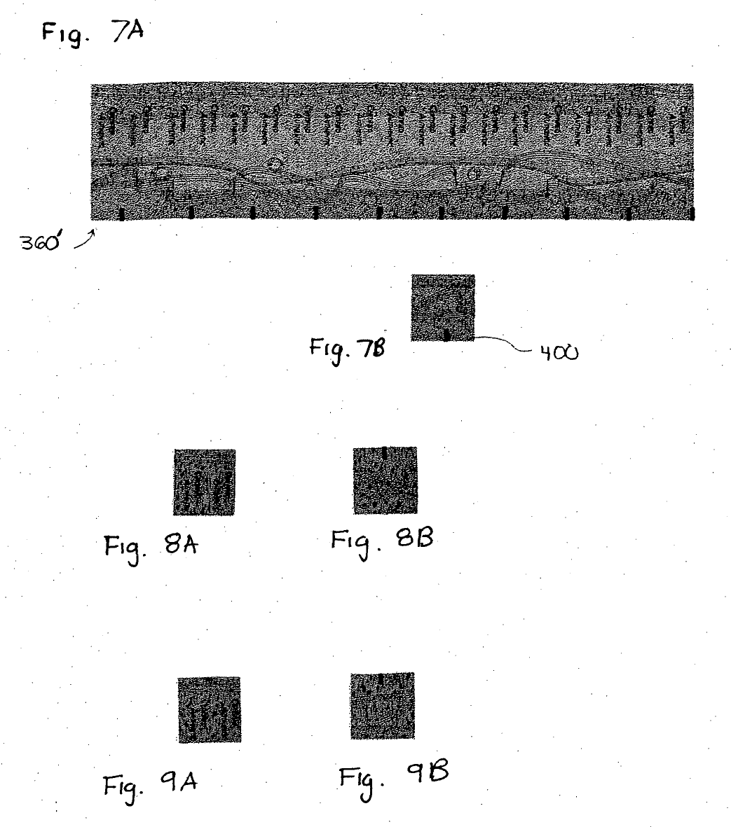

An individual label 400 processed from the ribbon of labels 360′ is shown in FIG. 7B. FIGS. 8A-9B also illustrate labels processed from the ribbon of labels of FIG. 7A.

The master repeat may be part of the ground or figure weaves, part of the weft or warp yarns which are chosen to make up the label ribbon. Recognizable designs such as logos, flowers, objects, or abstract designs may be part or whole of the master repeat.

Referring to FIGS. 7B, 8B, and 9B, the back of each authentic label has a design which can be compared to the master repeat to determine authenticity. The label back of FIG. 9B has been rotated 90° from the label back of FIG. 7B.

Therefore, according to the method of the present invention, a ribbon of labels having an over-lying repeat of a standard logo repeat length is produced. The ribbon of labels is then processed as described hereinabove, and the labels are cut and attached to the item or goods. To authenticate the good, the label having the design is compared to the master repeat. Because the label has a recognizable design it can be matched to the master repeat at some portion thereof. The finished label has a design which is difficult to copy without the knowledge of the master repeat design.

The finished labels can also incorporate an embedded identifying device, such as a RF device, as described hereinabove. Thus, the method and label of the present invention enables a two-tier level for authenticating goods.

Although the present invention has been described in relation to particular embodiments thereof, many other variations and modifications and other uses will become apparent to those skilled in the art. It is preferred therefore, that the present invention be limited not by the specific disclosure herein, but only by the appended claims.

What is claimed is:

1. A method of authenticating and or identifying goods comprising the steps of:
providing a master repeat of a recognizable design;
providing a length of a ribbon of material having the recognizable design repeated along the length thereof;
subdividing the ribbon of material into a plurality of individual labels, each of said plurality of labels having at least a portion of the recognizable design; and
comparing said labels having at least a portion of the recognizable design with the master repeat to determine the authenticity of said labels.

2. The method of claim 1, wherein the step of providing the length of ribbon comprises providing a ribbon of material formed of warp and weft yarns, said warp and weft yarns forming the recognizable design.

3. The method of claim 2, further comprising the step of folding the ribbon parallel to the warp yarn prior to subdividing the ribbon of material.

4. The method of claim 1, wherein the length of ribbon has a front and back and the step of providing the length of ribbon further comprises providing the repeat of the recognizable design along the back of the length of ribbon of material.

5. The method of claim 4, wherein the step of providing the length of ribbon further comprises providing a plurality of logo or text along the front of the length of ribbon of material.

6. The method of claim 1, further comprising the step of joining the ribbon of material having the repeat of the recognizable design with a ribbon of labels.

7. The method of claim 1, further comprising the step of attaching at least one device to the ribbon of material.

8. The method of claim 1, wherein the step of subdividing the ribbon of material comprises ultrasonically subdividing the ribbon of material into the plurality of labels.

9. A label made according to the method of claim 1.

10. A label made according to the method of claim 7.

11. A label formed from a ribbon of woven, thermoplastic material, comprising: a partial segment of a recognizable design, wherein said segment of recognizable design compares to a larger segment of a master design.

12. The label of claim 11, further comprising a device attached to the ribbon of material.

13. The label of claim 12, wherein the device is a radio frequency device.

14. The label of claim 11, further comprising a front and back, said partial segment of design being disposed on the back side of the label.

15. The label of claim 14, further comprising a logo or text disposed on the front of the label.
